(19) United States
(12) Patent Application Publication
(10) Pub. No.: US 2023/0345335 A1
(43) Pub. Date: Oct. 26, 2023

(54) Methods and Apparatus Improving Handoff (HO) Procedures in Varying Indoor Mobility of User Equipment (UE) Operating in Varying Indoor Environments

(71) Applicant: Celona, Inc., Campbell, CA (US)

(72) Inventors: Vanlin Sathya, Campbell, CA (US); Shashideep Nuggehalli, Campbell, CA (US); Srinivasan Balasubramanian, San Diego, CA (US)

(21) Appl. No.: 18/302,490

(22) Filed: Apr. 18, 2023

Related U.S. Application Data
(60) Provisional application No. 63/334,028, filed on Apr. 22, 2022.

(51) Int. Cl. H04W 36/24

(52) U.S. Cl. CPC H04W 36/24

(57) ABSTRACT

Methods and apparatus for improving handoff (HO) procedures in varying indoor mobility of User Equipment (UE) operating in varying indoor environments are disclosed.

### CLAIM OF PRIORITY TO PREVIOUSLY FILED PROVISIONAL APPLICATION—INCORPORATION BY REFERENCE

This non-provisional application claims priority to an earlier-filed provisional application No. 63/334,028 filed Apr. 22, 2022, entitled “Methods and Apparatus Improving Handoff (HO) Procedures in Varying Indoor Mobility of User Equipment (UE) Operating in Varying Indoor Environments” (ATTY DOCKET NO. CEL-066-PROV) and the provisional application No. 63/334,028 filed Apr. 22, 2022, and all its contents, are hereby incorporated by reference herein as if set forth in full.

### BACKGROUND

### (1) Technical Field

The disclosed methods and apparatus relate generally to wireless communication networks, and in particular, the disclosed methods and apparatus relate to improving the performance of Handoff (HO) procedures for indoor vehicular mobility experiencing varying indoor environments.

### (2) Background

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

It is commonplace today for communications to occur over a wireless network in which user equipment (UE) connects to the network via a wireless transceiver, such an eNodeB, gNodeB, access point or base station, hereafter referred to generically as a BS/AP (base station/Access Point). In this disclosure the term eNodeB is shortened to the term “eNB” or “gNB” and is used generically to refer to the following: a single sector eNB/gNB; a dual sector eNB/gNB, with each sector acting independently; and a node that supports both eNB and gNB functions. The UE may be a wireless cellular telephone, tablet, computer, Internet-of-Things (IoT) device, or other such wireless equipment. The BS/AP may be an eNodeB (“eNB”) as defined in 3GPP specifications for long term evolution (LTE) systems (sometimes referred to as 4^{th} Generation (4G) systems) or a gNodeB as defined in 3GPP specifications for new radio (NR) systems (sometimes referred to as 5G systems). Furthermore, the BS/AP may be a single sector node or a dual sector node in which each of two sectors act independently. In 4G and 5G systems, there are times when a relatively large number of UEs may be attempting to access the network through the same “cell”.

In many cases, there is a mix of UEs, some requiring high throughput with data arriving in bursts and other UEs requiring minimal throughput, but having frequent data transmit and receive requirements. The term ‘BS/AP” is used broadly herein to include base stations and access points, including at least an evolved NodeB (eNB) of an LTE network or gNodeB (gNB) of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

FIG. 1 is an illustration of components of a wireless communications network 100. In some embodiments, the communications network 100 comprises a Radio Access Network (RAN). It is commonplace today for communications to occur over a wireless network in which user equipment (UE) (such as, for example, UEs 101a, 101b, 101c, and 101d) connect to the network via a wireless transceiver, such an eNodeB (eNB), gNodeB (gNB), Access Point (or base station) 103, hereafter referred to generically as a BS/AP (base station/Access Point) or more simply, an Access Point (AP) 103. A wireless device operated by a user, commonly referred to as a “User Equipment” (UE), is typically in wireless communication with the Access Point (AP) 103, or, more specifically, via a base station antenna 130. Although only a single AP 103 is shown in FIG. 1, several APs 103 are used to communicate with a plurality of UEs 101 (such as, for example, UEs 101a, 101b, 101c and 101 d shown in FIG. 1) in typical communication network 100 deployments.

As shown in FIG. 1, the BS/AP 103 (or a plurality of BS/APs 103 which are not shown in FIG. 1 for simplicity's sake) communicate with an Edge Node 120. The Edge Node 120 communicates with the other components of the RAN 100 and the RAN Core Network 114, and allows users of the various UEs 101 access to services provided by the RAN 100 including those provided by the Internet 107. In some embodiments, the RAN Core Network 114 comprises a 5G Core Network (5GC).

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of components of a wireless communications network which in some embodiments comprises a Radio Access Network (RAN).

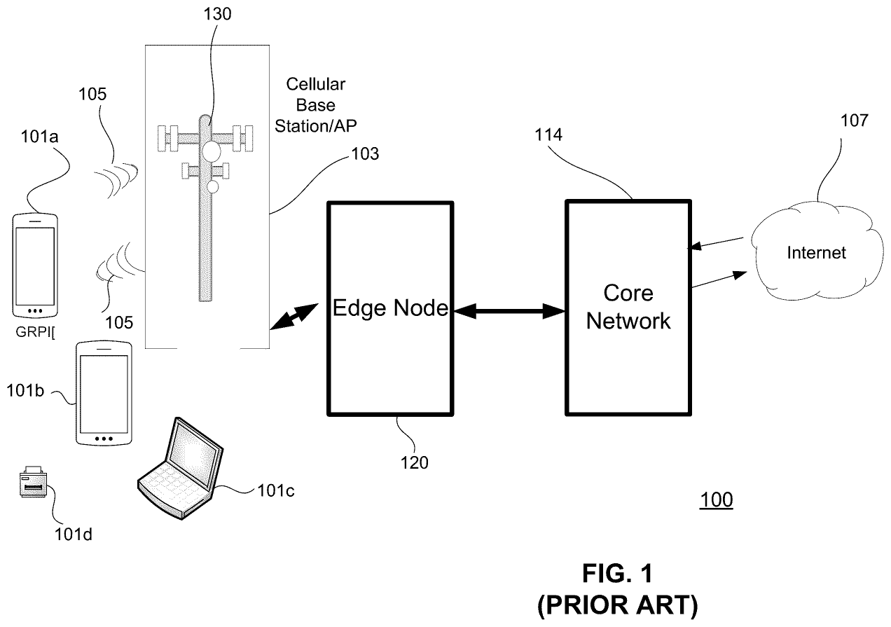

FIG. 2 shows a flow diagram for determining mobility classification prior to measurement of the UE.

FIG. 3 is a diagram showing Handover Support and Neighbor Ranking Flow in accordance with the disclosed methods and apparatus.

FIG. 4 is a diagram showing User and AP Graph Translation to a Rank Matrix.

FIG. 5 is a diagram of Controlling nodes of inner and outer loops in accordance with some embodiments of the disclosed methods and apparatus.

FIG. 6 shows a flow diagram for determining and generating the M×N Rank Matrix based upon, among other measurements, mobility classification of the UE.

FIG. 7 shows an HO Call Flow Diagram of CAT A to CAT B or CAT B to CAT B in accordance with the disclosed methods and apparatus.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

One of the problems addressed by the presently disclosed method and apparatus relates to Indoor Environments:
Indoor vehicular mobility faces HO failures due to varying indoor environments.

The following mobility issues can plague an enterprise deployment if the planning, configurations, and algorithms are not implemented optimally.
Ping-pong Handover
Late/Early Handover
Unnecessary handover
Configurations and Algorithms are potentially optimizable and controllable. But planning is a costly operation and potentially not repeatable.
User mobility can put a wrench into the planning works if not considered properly from a mobility signaling handling point of view and air interface management point of view.
The disclosed embodiments provide methods and apparatus for classification of users and an algorithm to optimize signaling handling during mobility.

Mobility Optimization Based on Mobility Prediction

The above problem has been approached in the following way:
Mobility classification for every user in the connected network;
Best Neighbor Selection during the time of HO; and
Mobility optimization in the form of setting up RRC context in the neighbor and reducing the core signaling overhead to a very minimum (path switch).

Mobility Classification

The classification of the user can happen in three ways:
1. Prior to the measurement
2. Real-time measurement during active transmission
3. Based on the history

Determining Device Mobility Status in Real-Time

The mobility types for devices are identified below. The section below describes methods for detecting the type of mobility for the individual devices.
Stationary
Pedestrian mobility
Vehicular mobility
Unknown
Others

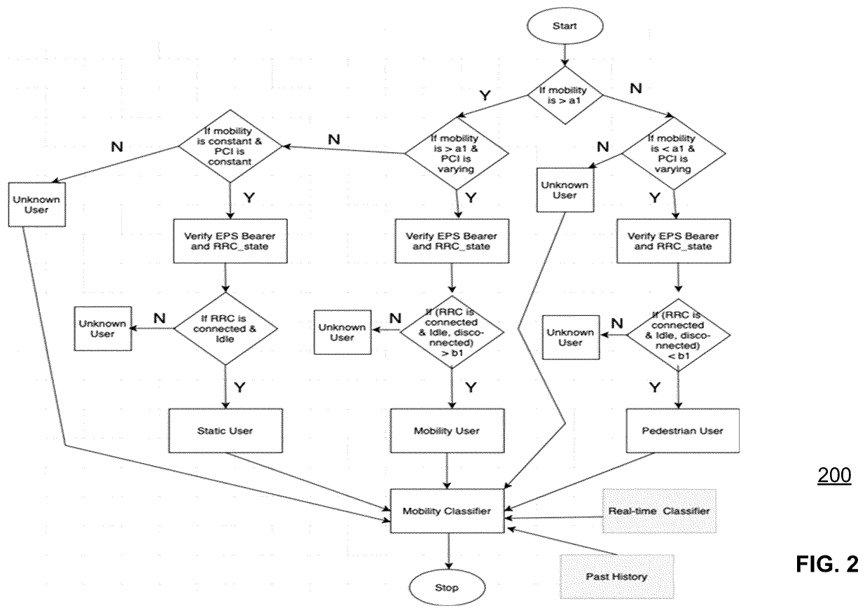

FIG. 2 shows a flow diagram for determining mobility classification prior to measurement of the UE.

The flow diagram shown in FIG. 2 allows a mobility classifier to perform initial classification prior to the measurement of the UE so in real-time measurement data such as RSRP, RSRQ, SINR, PCI ID variation, uplink power, latency, association time parameters can help the mobility classifier to identify the device group UE appropriately. On addition to the pre-measurement and real-time measurement, the past collected history data also helps the UE classification more reliably and accurately.

In some embodiments, depending upon the chipset and the location of the CBSD, AoA and OTDOA approaches are used to know the status of the mobility of the user. Some chipset support position reference signal (PRS) which helps to locate the UE more reliability in indoor and outdoor regions.

Classification Based on Real-Time Measurement

Determining Stationary
The stationary UEs are determined by less variations on the RSRP and RSRQ signals over certain delta time.
The UEs PCI or Cell ID does not vary over time.
The UEs with no handover link failure.
In full buffer transmission with GBR traffic, calculate the average number of RBs allocated within RCC_connected and RRC_disconnected states. If the number of RB allocations is more than the threshold, then the user is static.
The average modulation coding scheme does not vary over time. The UE will stay on the same MCS because of not much variation on the channel condition.
The behavior of the BLER should not vary over time: no additional frequency fading channel is added because of the user's constant velocity. Last 50 BLER slots observations used in the calculation.
The number of H-ARQs i.e, re-transmission attempts should be very minimum.
The average number of packet drops observed for this group is lesser than the threshold.
The latency of the users does not reach greater than 150 ms.
Last 50 power control slots in the UE uplink transmission.
The UE can go to sleep state i.e, DRX more often in this group because of quick transmission.

Determining Pedestrian Mobility
The UEs PCI vary less frequent over time.
The UEs with less ping-pong and less handover link failure (denoted by RRC_disconnected state).
The average modulation coding scheme, BLER vary less over time.
The UE transmission power varies with less fluctuation on PDSCH and PDCCH.
The UE can go to a balanced count of sleep and awake state.

Determining Vehicular Mobility
The RSRP and RSRQ signals will vary drastically over time.
The number of frequency/channel associations is more compared to pedestrian mobility user.
The jitter or latency will be high compared to stationary UEs.
In full buffer transmission, the average number of RBs allocated within RCC_connected and RRC_disconnected states will be very minimum.
The average modulation coding scheme vary over time from QPSK to 256-QAM.
The behavior of the BLER should vary over time due to the cell close, center, and edge region which leads to more frequency fading and doppler effect on the channel. Last 50 BLER slots observations used in the calculation.
The number of H-ARQs i.e, re-transmission attempts should be high compared to the static scenario.
The UE or uplink power transmission on the PDCCH and PDSCH will vary drastically from low to high TPC. The last 50 power slot values are used in the calculation.
The average number of packet drops observed for this group is higher than the threshold.
The latency of the users goes greater than 150 ms.
The average number of packet drops observed for this group is higher than the threshold.

Determining Unknown Mobility
The RSRP and RSRQ values are un-predictable, fluctuate over time.
The UEs associated with PCI are constant and variable over the short duration of time.
The BLER, UE TPC, MCS varies unpredictably.

Classification Based on History
Mobility profile—based on cell visited and amount of time stayed of a new service in the PSE that tracks every user's mobility profile (expensive job) from a number of cells and time visited per cell point of view. This can help to decide the final classification of the UE and the mobility can be triggered for faster mobility UE before others.

Best Neighbor Selection Based on History
Ideally one would know the neighbor to trigger handover based on HO reports and hysteresis. But that would mean that UE would have already gone into “HO region” and the onus would be on the network to ensure once the hysteresis is satisfied—everything else related to HO signaling happens quickly enough to ensure no call drop.
Neighbor selection by prediction would essentially help here to reduce this problem neighbor selection can be decided based on the kind of mobility types that the neighbor was subjected to in the last x mins and map that neighbor against the UE that matches the mobility type.
Neighbor selection can be decided based on mobility profile and a slightly aggressive trigger threshold-based HO reporting that gives the serving cell the position of the user due to report details. (Creation of a “A5bar” threshold).
Neighbor selection can be based on simply the aggregate number of handing handled in the last x mins.

Based on pre measurement, real-time measurement and past history helps to classify the UE more reliably and which in turn helps to derive the neighbor selection algo—neighbors are ranked (which discussed in detail based on positive and negative weights). Neighbor selection and ranking happens at the PSE service.

Using Device Mobility Status for Cell Assignment

Cell Assignment

Based on the mobility status, the centralized controller or RIC select the device between moving CAT-A and CAT-B.
If the UE mobility status is stationary, then connect the UE to CAT-A AP.
If the UE mobility status is pedestrian mobility, then still maintain the connection on CAT-A AP.
If the UE mobility status is vehicular mobility, then camp the UE on CAT-B.
If the UE mobility is unknown, the associate the UE on CAT-B AP until the mobility status is determined.

Carrier Aggregation

The CAT-A and CAT-B carrier aggregation are determined by the RIC controller based on CQI or SINR feedback to determine the less interference channel, availability of radio resources determined by the MAC schedule, nature of traffic determined based on the EPS bearer establishment and demand of traffic.

Dual Connectivity
The choice of dual connection on CAT-A and CAT-B is based on signal condition of two network, availability of radio resources, nature of traffic (GBR/N-GBR) and demand of traffic.
If the UE mobility is static and unknown, then no dual connectivity.
If the UE status is pedestrian and vehicular mobility, then the UE will connect to CAT-A and CAT-B.

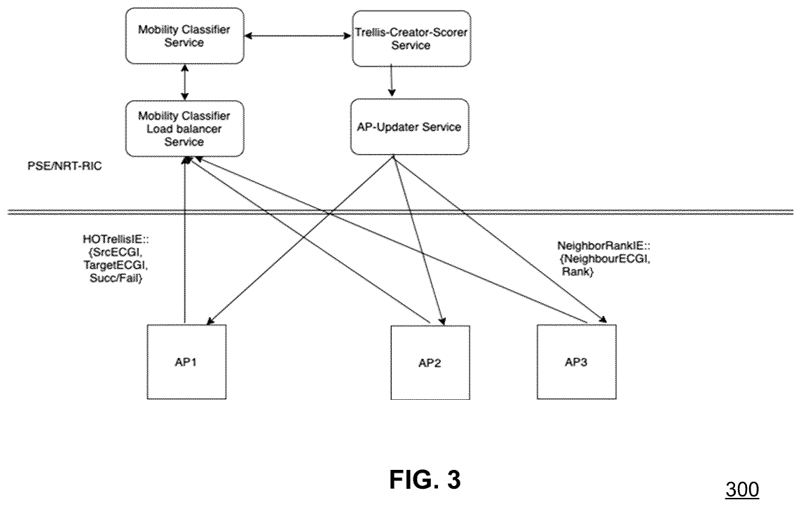

FIG. 3 is a diagram showing Handover Support and Neighbor Ranking Flow in accordance with the disclosed methods and apparatus.

Details regarding FIG. 3:
Based on the above classification, the algorithm knows when to initiate the classification, how often to change the classification, and the actors who help with the classification. The classification algorithm track both successful and failed handover.
This design can be visualized as an outer loop (classification algorithm) that feeds periodically into an inner loop. The details of the inner loop are proposed here in this presentation.
The objective of the inner loop would be to continuously set up neighbor ranks in every AP.

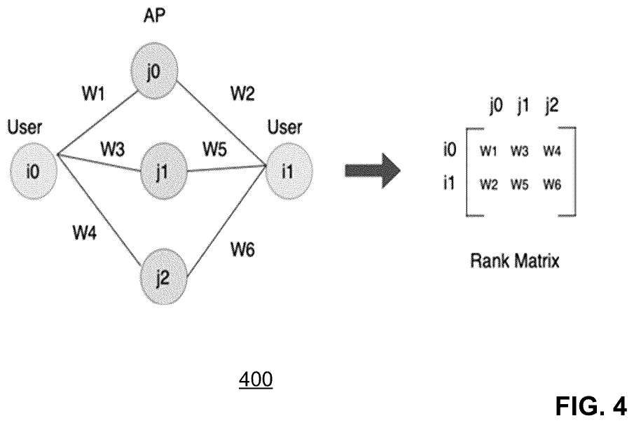

FIG. 4 is a diagram showing User and AP Graph Translation to a Rank Matrix.

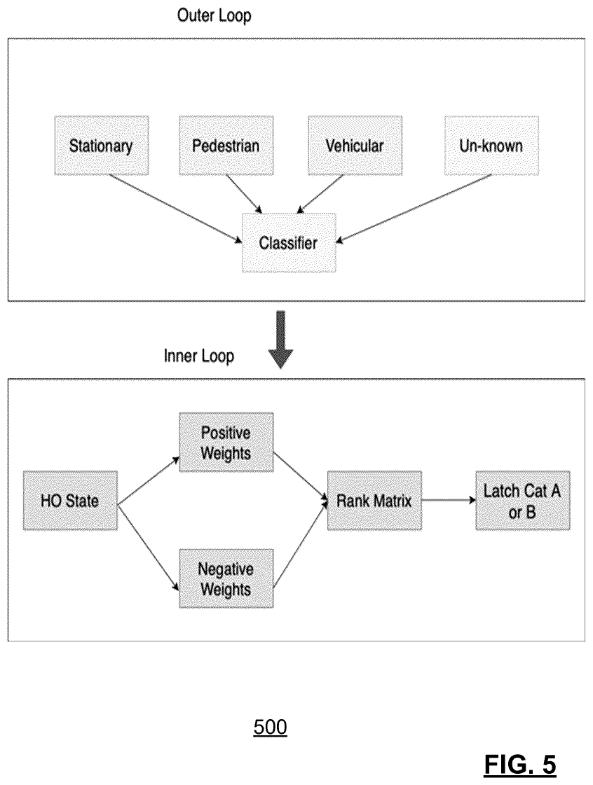

FIG. 5 is a diagram of Controlling nodes of inner and outer loops.

Outer Loop Function:
The outer loop is calculated based on the characteristics of the users and it can be defined as,
Update (user_i)={1 if user is in stationary state;
   0.75 if user is in pedestrian state;
   0.5 if user is in low mobility state;
   0.25 if user in high mobility state;
   0.1 if user is in unknown state;}

Inner Loop Function (See FIG. 5):

The user classification input is given to the inner loop function. Initially, the weight of the user_i is 0 and all the user_i weights are stored in the queue for some iterations to before making a final decision. Based on the RRC_Connected state and with successful data transmission, the state is defined as handover success, then update the user_i value will be summed in the weight counter i.e, positive weight,
Queue(user_i, AP_j).push(update(user_i));
Weight(user_i,AP_j)=Sum(Queue(user_i, AP_j);

If the UE encounter RRC_Disconnected state, then the state is defined as handover failure, then we will decrement (−) the weight i.e., negative weight,
Queue(user_i, AP_j).push(−update(user_i));
Weight(user_i,AP_j)=Sum(Queue(user_i, AP_j)

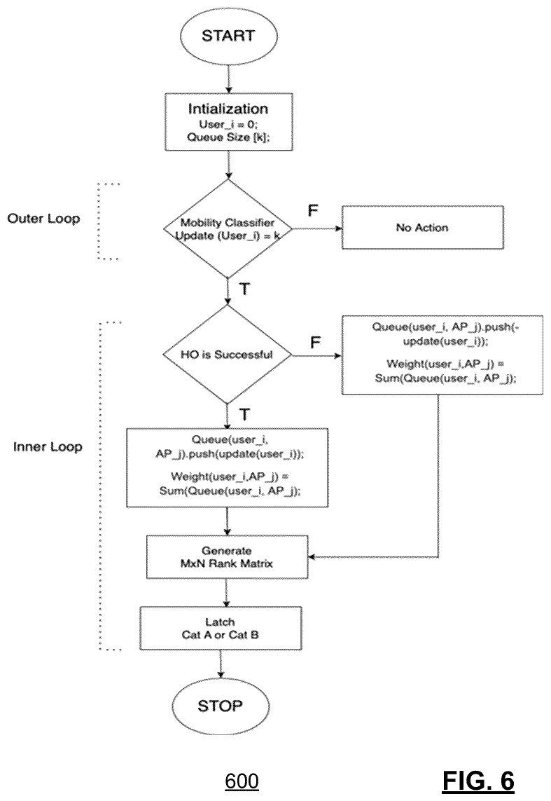

At the end based on the positive weights for user_i and AP_j and with the negative weights of user_i and AP_j, the rank matrix MXN is derived, where users={i . . . N} and AP={j, . . . , M}, as shown in the Flow Diagram of FIG. 6.

Mobility Training, Real-Time Detection, and Weight Calculation:
The mobility classification is done based on the characteristics of users in the outer loop, in terms of RSRP, RSRQ, PCI, link failure message i.e, RRC_Disconnected, successful handover i.e., RRC_Connected, etc
The outer loop mobility classifier can have the pre-collected or past collected data which is the ground truth information about the mobility state and at the same time, the outer loop can collect the real-time data (in the interval of several ms) to validate the decision.
If the characteristics are varying dynamically then the mobility training with the real-time will happen with the confidence interval of 100 ms and then finally it will get updated in the Update (user_i). This process is continuous in the interval of 100 ms.
If the characteristics are not varying drastically then the mobility training with the real-time will happen with the confidence interval of every 500 ms and then finally it will get updated in the Update (user_i). This process is continuous in the interval of 500 ms.
Based on the mobility training and number of successful or failure handovers, the weight calculation is updated accordingly.

Handover Support Algorithm:
The algorithm host will maintain a grid(trellis) of eNodeb and UE deployment connections.
Initially, all the edges are assigned with low values
Every time-post a successful handover and subsequent UE mobility classification is completed, the grid gets updated with a score that is based on classification—with the high-speed mobility classification updating the edge connecting the source and target eNodeb with the highest score and so on.
HO success is understood by receipt or non-receipt of UE release command at the source before the t-overall-really timer expiry. So, in case of a HO failure, a predefined number is subtracted from the existing score of the edge. This allows for both positive and negative reinforcement of the edge score
The periodically weighted value of every edge's score is compared against the weighted value of the sum of the previous 10 relevant scores to arrive at the neighbor Rank.
Once the neighbor ranks are updated to the eNodeb, the eNodeb can decide to set up pre-emptive rrc sessions via proprietary protocols based on existing load and load balancing routines either in the top two neighbors or all neighbors.

HO Call Flow:

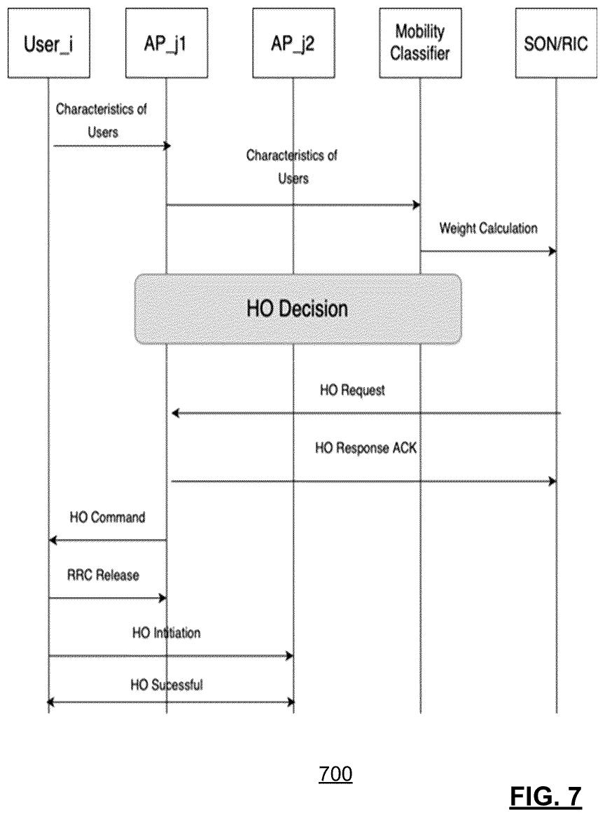

FIG. 7 shows an HO Call Flow Diagram of CAT A to CAT B or CATB to CAT B.

Based on the weight calculation and rank matrix, the SON or RIC will initiate the HO command to release the RRC connection to RRC Disconnected state, then AP initiate the new request to CAT A or CAT B accordingly.

Other Examples of Methods to Classify AGV Devices:

Challenges in AGV Classification:
A typical indoor cellular deployment will have users that typically either fit a static mobility profile or pedestrian mobility profile.
But there can be examples of indoor deployments like factory floors or warehouses where there are AGVs deployed that may not fit the mobility profiles mentioned above.
And considering the cell radius typically provided by Aps in indoor deployments, it is very important to ensure that the link-layer mobility schemes and network layer mobility schemes are set up in such a way that seamless connectivity and uninterrupted service delivery is maintained to the greatest extent possible.
So, it is important to understand the mobility profile of the user to decide the kind of scheme to deployed for both link and network layer mobility management. So, classification of the mobility profile of the user is necessary. The classification does not dictate or override link adaptation or power control schemes. The document does not dictate or override resource allocation schemes.
As a part of network layer mobility management, the above-mentioned classification is used to trigger specific actions to ensure uninterrupted service delivery. The added intent here is to ensure that the selected scheme and action is scalable and reliable and more importantly robust

How to Classify AGV if the User Profile is Fast Mobility Profile or not
The classification is performed in the following way
   Handin user and Registering User
      The last 50 Power control commands are tracked in the serving cell every specified “x” interval
      The last 50 BLER reports in DL and UL are tracked in the serving cell every specified “x” interval
      The weighted sum of BLER and Power control commands is calculated every specified “x” interval
      The weighted sum of BLER and Power Control commands in every specified “x” interval is considered as input for classification after “n” amount of “x” specified intervals
      When an AP is seeing rapid doppler due to a fast mobility UE, the reactions will be seen in both power control and link adaptation commands where the power control would tend to push UE Tx power higher and bler will tend to make link adaptation more conservative.
      Whereas in a non-doppler scenario, the power control commands will be relatively constant and link adaptation may hover around a mean for that set tx power to maximize channel gain.
      So, the weights against BLER ad Power control can be set up in such a way that weight associated towards power control is lesser than weight associated with BLER in a system that has conservative power control and relatively aggressive link adaptation.
      And the final threshold comparison can be an experimentally derived number. If the weighted sum of bler and power control commands after “nx” interval is greater than the threshold then it will denote an imbalance as both power control command values and Bler will be varying. If it less than or equal to threshold it will denote that RF is being reflected by the BLER seen and hence it is not a fast mobility user
   Handin user
      Additionally, Mobility history (including time spent in the previous cells) can be maintained for every handin user associated to a serving cell. This can be retrieved from Handover container IE that provides UE history. The information about time spent in the source cell can be proactively updated from the source cell of every handover post a successful handover.
      Median time of stay in last “y” cells from this history can be considered along with the above weighted sum to lend credence to classification with additional confirmation.

Average BLER at x Interval:

$${ABLER}_{i}^{jk} = \frac{{\sum }_{t = 1}^{50} {BLER}_{it}^{jk}}{50} \qquad ( 1 )$$

Average Power at x Intervals in DL:

$${AP}_{i}^{jk} = \frac{{\sum }_{t = 1}^{50} {P}_{it}^{jk}}{50} \qquad ( 2 )$$

Average Power at x Intervals in UL:

$${AP}_{i}^{kj} = \frac{{\sum }_{t = 1}^{50} {P}_{it}^{jk}}{50} \qquad ( 3 )$$

Average ABLER Over n Intervals:

$${AABLER}^{jk} = \frac{{\sum }_{i = 1}^{n} {ABLER}_{i}^{jk}}{n} \qquad ( 4 )$$

Average Power Over n Intervals in DL:

$${AAP}_{}^{jk} = \frac{{\sum }_{i = 1}^{n} {AP}_{i}^{jk}}{n} \qquad ( 5 )$$

Average Power Over n Intervals in UL:

$${AAP}^{kj} = \frac{{\sum }_{i = 1}^{n} {AP}_{i}^{kj}}{n} \qquad ( 6 )$$

Standard Deviation (S.D) for BLER Over n Intervals:

$$S . {D}_{BLER}^{jk} = \sqrt{\frac{{\sum }_{i = 1}^{n} {( {ABLER}_{i}^{jk} - {AABLER}^{jk} )}^{2}}{n}} \qquad ( 7 )$$

Standard Deviation (S.D) for Power Over n Intervals in DL:

$$S . {D}_{P}^{jk} = \sqrt{\frac{{\sum }_{i = 1}^{n} {( {AP}_{i}^{jk} - {AAP}^{jk} )}^{2}}{n}} \qquad ( 8 )$$

Standard Deviation (S.D) for Power over n intervals in UL:

$$S . {D}_{P}^{kj} = \sqrt{\frac{{\sum }_{i = 1}^{n} {( {AP}_{i}^{kj} - {AAP}^{kj} )}^{2}}{n}} \qquad ( 9 )$$

The equation M determines the no mobility and the mobility user.

M=α_{B}S.D_{BLER}^{jk}+α_{P}D*S.D_{P}^{jk}+α_{P}U*S.D_{P}^{kj} (10)

The t^{jk} determines the time spent by j in k^{th} AP/BS.

N=Median{t^{jk}:∀k} (11)

Determination of No mobility and High mobility:

if((M<βₘ)(N<βₙ)) then No Mobility else High Mobility (12)

How to Classify AGV if the User Profile is Fast Mobility Profile or not
The optimization of the value's “n”, “x” and the value “y” is very important for success of classification and implicitly the main goal of uninterrupted service delivery
The value's “x” and “n” should be decided based on indoor deployment planning. There can be two kinds of deployments —Homogenous deployments (where the network deployment involves cells beside each other or abutting each other or having nontrivial overlapping area) and heterogenous deployments (where there is either overlay or a need to do network layer mobility-based load balancing)
The value “x” should be as granular as possible to capture the doppler impact. The value “n” should be selected in such a way that classification is completed, and action is taken before uplink becomes untenable.
It can be observed that this classification scheme implicitly ensures that network layer mobility management schemes can be triggered due to uplink imbalance if the downlink reference signal-based event triggers don't get activated due to external factors predictably.

How to Use the AGV Classification
Once a user's mobility profile is marked as fast mobility, additional actions will help with ensuring uninterrupted service delivery.
As a first step it can involve setting up a more conservative threshold for network layer mobility trigger. This creates a potential “Region” (once reported as exceeded by the UE) before the identified cell level network layer mobility trigger kicks in. (network layer mobility trigger can either be for load balancing necessitated network assisted handover or a regular Mobile assisted handover)
This region must be effectively utilized for these fast mobility users.
This can be utilized for setting up a context in the target before the cell level network trigger kicks in (here the assumption is the target cell's credentials like ECGI, and if required Transport Network Layer Address for X2/Xn; should be known). This would be very helpful for network assisted handovers since the predictable time delay of core setup can be taken care of ahead of time to allow for air interface uncertainty. In both mobile assisted handover and Network assisted handovers this can be used for retrieving the required credentials like ECGI (and if required TNL)
The advance setup of a context would follow the same admission control approach that a normal hand in user would follow if the handover call flow is followed without doing the preemptive context setup.
   The context tear down can be initiated by expiry of timer that is a defined multiples of TS1RELOCOverall.—that tracks the complete handover operation from the moment of handover trigger
   The number of sessions that can be setup can be defined as a fixed percentage fraction of the CFRA preambles maintained in the AP.
   The number of handin users can be an overriding number on top of the above considering the capacity a base station should support for originating users.
In this “region” the link layer management like power control and link adaptation can also be made conservative to ensure the ongoing operation is not affected by higher spectral efficiency. Additionally, frequency hopping can also be setup to ensure diversity gain is provided to the UE

Application Benefits in Indoor, Outdoor, and Mix of Indoor and Outdoor:
Only Indoor: In an application like a warehouse, the deployment of more robots leads to vehicular mobility scenarios. For example Symbotic
Mix of Indoor and Outdoor: In the application like education campus, the students, security camera around the campus leads to pedestrian and stationary mobility scenario.
Only Outdoor: In an application like a parking lot or outdoor manufacturing unit, the scenarios of pedestrian, static, vehicular mobility are possible

Use Case Visualization:

Devices categorization for HO: High mobility. Low mobility

Deployment: CAT-A Cells with overlapping footprint with CAT-B cells

Device mobility type determination:
Known based on device type and configured into the system (e.g., automotive robots implicitly classified as a high mobility device)
Realtime predictions (e.g., handhelds that are traveling with an individual sitting on indoor transportation)

Behavior for High Mobility Devices:
The PCC allocation is typically provided on CAT-B cells: Mobility transitions amongst CAT-B cells are employed.
   Assumes ubiquitous coverage indoors with CAT-B cells, which may not be true for all scenarios.
      Measurement requests for CAT-B and CAT-A cells from the UE are employed to make appropriate decisions for transitioning PCC to another CAT-B cell or to a CAT-A cell.
      If transitioned to a CAT-A cell, the device is moved back to a CAT-B cell at the earliest opportunity.
   CAT-B cells may get overloaded.
      The SCC allocation with CAT-A and using the SCC for data traffic will be used for load balancing.
      It is possible for configurations where only DL CA is supported and no UL CA. PCC transitions to CAT-A cells will be required to address load balancing. The HO and load balancing procedures with CAT-A cells will be employed in such scenarios (described in IDF050).
The SCC allocation is done with CAT-A cells when in the footprint of CAT-A
The device on extended stationary scenarios is assigned a CAT-A cell as PCC

Behavior for Low Mobility Devices:
The PCC allocation is typically provided on CAT-A cells while indoor and CAT-B cells while outdoor
The SCC allocation is done with CAT-A cells when in the footprint of CAT-A.

### CONCLUSION

Methods and apparatus improving handoff (HO) procedures in varying indoor mobility of User Equipment (UE) operating in varying indoor environments are disclosed.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for detecting a type of mobility for an individual device, the method comprising:
a. Determine whether mobility is greater than a first predetermined value;
b. If mobility is greater than the predetermined value, determine whether PCI is varying;
c. If PCI is varying, then verify EPS bearer and RRC state; and
d. If the RRC state indicates connected and idle, disconnected is greater than a second predetermined value.
